(19) United States
(12) Patent Application Publication
(10) Pub. No.: US 2026/0199870 A1
(43) Pub. Date: Jul. 16, 2026

(54) NANOCOMPOSITE MATERIAL FOR ADSORPTIVE REMOVAL OF ORGANIC POLLUTANTS

(71) Applicant: KING FAHD UNIVERSITY OF PETROLEUM AND MINERALS, Dhahran (SA)

(72) Inventors: Sagheer A. ONAIZI, Dhahran (SA); Muhammad Shariq VOHRA, Dhahran (SA); Waleed K. AL-NOWAISER, Dhahran (SA)

(73) Assignee: KING FAHD UNIVERSITY OF PETROLEUM AND MINERALS, Dhahran (SA)

(21) Appl. No.: 19/020,974

(22) Filed: Jan. 14, 2025

(30) Foreign Application Priority Data
Jan. 12, 2025 (SA) 1020250188

(51) Int. Cl. B01J 20/22; B01J 20/20; B01J 20/28; B01J 20/30; C02F 1/28; C02F 101/30; C02F 101/34

(52) U.S. Cl. CPC B01J 20/226; B01J 20/20; B01J 20/28016; B01J 20/3071; B01J 20/3078; B01J 20/3085; C02F 1/288; C02F 1/283; C02F 1/285; C02F 2101/308; C02F 2101/345

(57) ABSTRACT

A nanocomposite material includes graphene oxide (GO) and a zeolitic imidazolate framework-7 (ZIF-7). The graphene oxide is present in an amount of 25 percent by weight (wt. %) to 40 wt. % based on a total weight of the nanocomposite material. The nanocomposite is in the shape of particles with a longest dimension of 0.5 micrometers (μm) to 5 μm.

### CROSS-REFERENCE TO RELATED APPLICATION

The present disclosure claims the benefit of Saudi patent application No. 1020250188, filed on Jan. 12, 2025, with the Saudi Authority for Intellectual Property Office, which is incorporated herein by reference in its entirety.

### BACKGROUND

### Technical Field

The present disclosure is directed towards water decontamination techniques, and more particularly, relates to a nanocomposite material having a graphene oxide (GO) and zeolitic imidazole framework-7 (ZIF-7).

### Description of Related Art

Water pollution is a major worldwide problem that endangers the survival and development of human beings and society. Presently, dye (artificial color) is widely used in the industries such as weaving, papermaking, printing, foods, cosmetics, and other industries. Waste from the aforementioned industries is discharged in water bodies and environment surrounding industrial establishments. The dye waste is toxic in nature and pollutes water bodies and soil beyond safe consumption levels. At present, dyes are sophisticated, and anti-light degradation, anti-oxidation, and anti-biodegradation capabilities are constantly being improved. Hence, treatment of wastewater contaminated with dye waste and the effective and efficient removal of organic pollutants from water has become a serious concern. Existing methods and techniques include coagulation, biodegradation, precipitation, chemical oxidation, adsorption, absorption and the like. Among the aforementioned techniques, adsorption is considered favorable and may effectively remove dye molecules. However, traditional adsorbing materials such as activated carbon, natural minerals and industrial residues are inefficient and slow to treat the contaminated water due to the sophisticated molecular structure of modern dyes, resulting in limited adsorbing capacity. Further, metal-organic framework (MOFs) have become favorable materials for liquid-phase adsorptive removal of organic pollutants. MOFs possess properties such as large adsorption capacity, high surface area, tunable porosity, hierarchical structure, and recyclability. In addition, graphene oxide (GO) has unique characteristics that provide utility in water purification applications. GO is chemically stable in water, provides a high water permeability through 2D nanochannels, and has exceptional antifouling and antibacterial properties. Presently, GO-based membranes have been developed to improve membrane performance for various water filtration applications such as reverse osmosis, pervaporation, and forward osmosis. However, GO alone lacks definitive properties to tackle toxic pollutants such as dyes.

Each of the aforementioned methods and materials suffers from one or more drawbacks hindering their adoption. Accordingly, it is one object of the present disclosure to provide a nanocomposite for removal of organic pollutants from contaminated waters that may circumvent the above stated limitations, such as low efficiency, poor adhesion capacity, and inability to sufficiently to remove toxic dye waste, of the present methods.

### SUMMARY

In an exemplary embodiment, a nanocomposite material is described. The nanocomposite material includes graphene oxide (GO) and a zeolitic imidazolate framework-7 (ZIF-7). The graphene oxide is present in an amount of 25 to 40 percent by weight (wt. %) based on a total weight of the nanocomposite material. The nanocomposite is in the shape of particles with a longest dimension of 0.5 micrometers (μm) to 5 μm.

In some embodiments, the graphene oxide is present in the nanocomposite material in an amount of 30 wt. % to 35 wt. % based on the total weight of the nanocomposite material.

In some embodiments, the ratio of relative atomic concentrations of nitrogen to zinc is in a range from 2.5 to 5.

In some embodiments, the ratio of relative atomic concentrations of nitrogen to zinc is in a range from 3.0 to 4.5.

In some embodiments, the material has an uptake capacity for methyl orange of 3800 milligrams per gram (mg/g) to 4000 mg/g at an initial concentration of 500 milligrams per liter (mg/L) of the methyl orange.

In some embodiments, the material has an uptake capacity for methyl orange of 700 mg/g to 900 mg/g at an initial concentration of 100 mg/L of the methyl orange.

In some embodiments, the material has an uptake capacity for o-cresol of 1300 mg/g to 1500 mg/g at an initial concentration of 500 mg/L of the o-cresol.

In some embodiments, the material has an uptake capacity for o-cresol of 350 mg/g to 550 mg/g at an initial concentration of 100 mg/L of the o-cresol.

In some embodiments, a process of making the nanocomposite material is described. The process includes dissolving a zinc salt in a polar protic solvent to form a zinc solution, adding graphene oxide to the zinc solution to form a first solution, sonicating the first solution, and dissolving a benzimidazole in the polar protic solvent to form a second solution. The process further includes mixing the first solution and the second solution to form a third solution, autoclaving the third solution for 20 to 30 hours at a temperature of 120° C. to 140° C. to form a product. The product is washed in the polar protic solvent, and drying the product at 40° C. to 60° C. to form the nanocomposite material.

In some embodiments, the zinc salt is Zn(NO₃)₂·6H₂O.

In some embodiments, the concentration of Zn(NO₃)₂·6H₂O in the third solution is in a range from 0.15 to 0.35 M.

In some embodiments, the polar protic solvent is methanol.

In some embodiments, the amount of GO present in the first solution is in a range from 10 to 30% of the weight of zinc present in the first solution.

In some embodiments, the concentration of benzimidazole in the third solution is in a range from 0.5 M to 1.5 M.

In some embodiments, the sonicating the first solution is performed for 20 to 40 minutes with cycles of a 30 second pulse on followed by a 3 second pulse off.

In some embodiments, the autoclaving the third solution is for 24 hours at a temperature of 130° C.

In another exemplary embodiment, a method of water decontamination is described. The method includes contacting the nanocomposite material with an aqueous solution to form a reaction mixture. The aqueous solution includes one or more pollutants. The method further includes mixing the reaction mixture and collecting a filtrate. The filtrate has fewer of the one or more pollutants than the aqueous solution.

In some embodiments, the concentration of nanocomposite material in the reaction mixture is in a range from 50 to 150 mg/L.

In some embodiments, the contacting the nanocomposite material of claim 1 with an aqueous solution is performed for 20 to 28 hours.

In some embodiments, the mixing the reaction mixture is performed by shaking the reaction mixture between 200 revolutions per minute (rpm) and 300 rpm.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flowchart depicting the synthesis of nanocomposite (GO@ZIF-7), according to certain embodiments.

FIG. 1B is a schematic flowchart depicting method of water decontamination, according to certain embodiments.

FIG. 2 shows X-ray diffraction (XRD) patterns of graphene oxide (GO), zeolitic imidazolate framework-7 (ZIF-7), and GO@ZIF-7 nanocomposite, according to certain embodiments.

FIG. 3 depicts Fourier transform infrared (FTIR) spectra of GO, ZIF-7, and GO@ZIF-7 nanocomposite, according to certain embodiments.

FIG. 4A is a scanning electron microscopy (SEM) image of GO at 3 micrometers (μm) magnification, according to certain embodiments.

FIG. 4B is a SEM image of GO at 500 nanometres (nm) magnification, according to certain embodiments.

FIG. 4C is a SEM image of ZIF-7 at 3 μm magnification, according to certain embodiments.

FIG. 4D is a SEM image of ZIF-7 at 500 nm magnification, according to certain embodiments.

FIG. 4E is a SEM image of GO@ZIF-7 nanocomposite at 3 μm magnification, according to certain embodiments.

FIG. 4F is a SEM image of GO@ZIF-7 nanocomposite at 500 nm magnification, according to certain embodiments.

FIG. 5A is an optical image depicting the presence of nitrogen (N) in the elemental mapping of the GO@ZIF-7 nanocomposite, according to certain embodiments.

FIG. 5B is an optical image depicting the presence of carbon (C) in the elemental mapping of the GO@ZIF-7 nanocomposite, according to certain embodiments.

FIG. 5C is an optical image depicting the presence of oxygen (O) in the elemental mapping of the GO@ZIF-7 nanocomposite, according to certain embodiments.

FIG. 5D is an optical image depicting the presence of zinc (Zn) in the elemental mapping of the GO@ZIF-7 nanocomposite, according to certain embodiments.

FIG. 5E depicts energy dispersive X-ray spectroscopy (EDS) results for the GO@ZIF-7 nanocomposite, according to certain embodiments.

FIG. 6 is a graph depicting benchmark methyl orange (MO) adsorption performance of GO, ZIF-7, and GO@ZIF-7 nanocomposite, according to certain embodiments.

FIG. 7 is a graph depicting benchmark o-cresol (OC) adsorption performance of GO, ZIF-7, and GO@ZIF-7 nanocomposite, according to certain embodiments.

FIG. 8A is a face-centered response surface methodology (FC-RSM) modelling graph depicting pH and adsorbent dosage effects at a fixed initial MO concentration of 100 milligrams per litre (mg/L), according to certain embodiments.

FIG. 8B is a FC-RSM modelling graph depicting pH and initial MO concentration effects at a fixed adsorbent dosage of 400 mg/L, according to certain embodiments.

FIG. 8C is a FC-RSM modelling graph depicting initial MO concentration and adsorbent dosage effects at affixed solution pH of 4, according to certain embodiments.

FIG. 9A is a FC-RSM modelling graph depicting pH and adsorbent dosage effects at a fixed initial OC concentration of 100 mg/L, according to certain embodiments.

FIG. 9B is a FC-RSM modelling graph depicting pH and initial OC concentration effects at a fixed adsorbent dosage of 400 mg/L, according to certain embodiments.

FIG. 9C is a FC-RSM modelling graph depicting initial OC concentration and adsorbent dosage effects at affixed solution pH of 4, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “graphene oxide” refers to a derivative of graphene that has been chemically modified to introduce oxygen-containing functional groups. These groups, such as hydroxyl, epoxy, and carboxyl, are integrated into the graphene structure, resulting in increased hydrophilicity and improved dispersibility in polar solvents. Graphene oxide retains the unique properties of graphene, such as high surface area, mechanical strength, and electrical conductivity, while also exhibiting enhanced reactivity due to the presence of functional groups. This makes graphene oxide particularly suitable for various applications, including nanocomposites, sensors, and environmental remediation, as it can interact more effectively with other materials and pollutants.

As used herein, the term “metal-organic framework (MOF)” refers to a class of crystalline materials composed of metal ions or clusters coordinated to organic ligands, forming a three-dimensional network. MOFs are characterized by their high surface area, tunable pore sizes, and remarkable structural diversity, which make them ideal for various applications, including gas storage, separation, catalysis, and drug delivery. The arrangement of metal ions and organic linkers within the framework creates a porous structure that can selectively adsorb small molecules, enabling efficient capture and release processes. MOFs are of interest in materials science and nanotechnology due to their unique properties and versatility in addressing environmental and industrial challenges.

As used herein, the term “zeolitic imidazolate framework” (ZIF) refers to a subclass of metal-organic frameworks (MOFs) characterized by their zeolite-like structures and imidazolate linkers. ZIFs are composed of metal ions, commonly zinc or cobalt, coordinated to imidazolate ligands, resulting in a porous crystalline architecture. These materials exhibit high thermal and chemical stability, tunable pore sizes, and a large surface area, making them suitable for applications such as gas storage, separation, catalysis, and sensing. The unique structural features of ZIFs enable selective adsorption of molecules, enhancing their effectiveness in environmental remediation and industrial processes. Their ability to combine the properties of zeolites with those of organic frameworks contributes to their growing importance in materials science.

As used herein, the term “ZIF-7” refers to a type of zeolitic imidazolate framework, specifically characterized by its three-dimensional crystalline structure formed from zinc ions coordinated to imidazolate linkers. This metal-organic framework (MOF) exhibits exceptional porosity, high surface area, and tunable pore sizes, making it suitable for various applications, including gas adsorption, separation, and catalysis. ZIF-7 is known for its stability under ambient conditions and has a unique square planar structure, which contributes to its ability to selectively capture small molecules and organic pollutants. Its integration into nanocomposites, such as those with graphene oxide, enhances the material's overall functionality, particularly in environmental applications like wastewater treatment and pollutant removal.

As used herein, the term “polar protic solvent” refers to a class of solvents that have a high dielectric constant and contain an —OH (hydroxyl) or —NH (amino) group, allowing them to form hydrogen bonds. These solvents are characterized by their ability to dissolve ionic compounds and polar molecules, facilitating chemical reactions and interactions in various applications. Common examples of polar protic solvents include water, methanol, ethanol, and acetic acid. Their polar nature and hydrogen-bonding capabilities make them effective in promoting solvation and stabilizing charged species, which is useful in processes such as extraction, chromatography, and organic synthesis.

As used herein, the term “water decontamination” refers to the process of removing harmful contaminants, pollutants, or pathogens from water to make it safe for consumption, recreation, or discharge into the environment. This process can involve various methods, including physical, chemical, and biological techniques, aimed at reducing the concentration of toxic substances such as heavy metals, organic pollutants, pathogens, and nutrients that can adversely affect human health and aquatic ecosystems. Effective water decontamination improves water quality, protects public health, and maintains ecological balance in aquatic environments.

As used herein, the term “uptake capacity” refers to the maximum amount of a specific substance, typically a pollutant or contaminant, that a material or adsorbent can effectively adsorb or capture per unit mass of the adsorbent. It is usually expressed in units such as milligrams of pollutant per gram of adsorbent (mg/g). Uptake capacity is a useful parameter in evaluating the effectiveness of adsorbents in applications such as water treatment, as it indicates how well the material can remove contaminants from aqueous solutions. Higher uptake capacity signifies a more efficient adsorbent, optimizing environmental remediation processes.

Aspects of this disclosure are directed to a method of synthesizing GO@ZIF-7 nanocomposite for the adsorptive removal of organic pollutants from contaminated waters. The GO@ZIF-7 nanocomposite improves this process with its high surface area and tunable properties, providing enhanced adsorption capacity for contaminants like methyl orange and o-cresol, thus enabling efficient and sustainable water decontamination. Adsorption is advantageous over other techniques like filtration and chemical treatment because it effectively captures a wide range of organic pollutants without generating harmful byproducts, making it environmentally friendly.

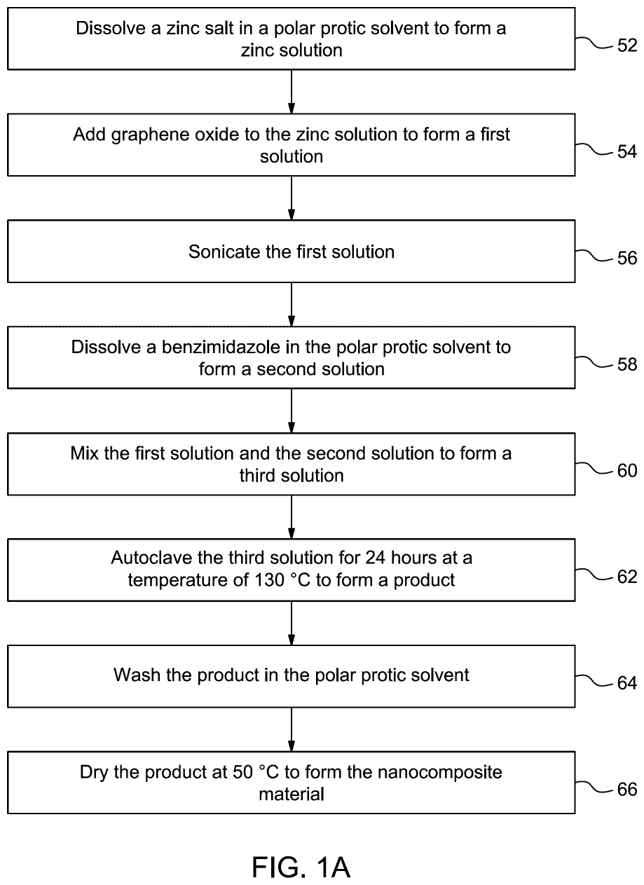

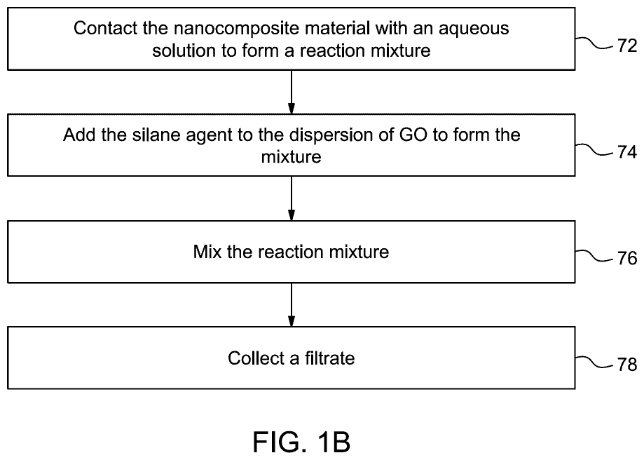

FIG. 1A illustrates a schematic flow chart of a method 50 of synthesizing GO@ZIF-7 nanocomposite. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes dissolving a zinc salt in a polar protic solvent to form a zinc solution. In some embodiments, zinc salt may be zinc acetate (Zn(CH₃COO)₂), zinc sulfate (ZnSO₄), zinc chloride (ZnCl₂), zinc carbonate (ZnCO₃), zinc phosphide (Zn₃P₂), and/or hydrates thereof. In a preferred embodiment, the zinc salt is Zn(NO₃)₂·6H₂O.

Polar protic solvents are characterized by their ability to form hydrogen bonds and their polar nature, allowing them to effectively dissolve ionic and polar compounds. Suitable examples of polar protic solvents may include, but are not limited to, water, ethanol, isopropanol, acetic acid, and formic acid. In a preferred embodiment, the polar protic solvent is methanol. The polar protic solvent, such as methanol, possesses both polar characteristics and the ability to form hydrogen bonds due to the presence of hydroxyl groups. The choice of a polar protic solvent, such as methanol, plays a role in the dissolution process of ionic compounds like zinc nitrate hexahydrate (Zn(NO₃)₂·6H₂O) by stabilizing the resulting zinc ions in solution and facilitating effective interactions between the solvent molecules and the zinc salt.

At step 54, the method 50 includes adding graphene oxide to the zinc solution to form a first solution. Graphene oxide is a two-dimensional material known for its high surface area, excellent mechanical properties, and unique electrical characteristics. When introduced to the zinc solution, the polar protic solvent aids in the dispersion of GO, allowing it to interact effectively with the zinc ions present in the solution. This interaction occurs as the functional groups on the surface of graphene oxide, such as hydroxyl, carboxyl, and epoxy groups, form hydrogen bonds and coordinate with the zinc ions. The uniform distribution of graphene oxide within the solution also plays a role in improving the mechanical stability and structural integrity of the resulting nanocomposite, leading to enhanced adsorption properties for applications in water decontamination. In some embodiments, the amount of GO present in the first solution may range from 10 to 15%, 10 to 20%, 10 to 25%, 20 to 30%, and 25 to 30% of the weight of zinc present in the first solution. In a preferred embodiment, the amount of GO present in the first solution is 18% of the weight of zinc present in the first solution.

At step 56, the method 50 includes sonicating the first solution. Sonicating the first solution enhances the dispersion and homogeneity of graphene oxide (GO) within the zinc solution. This improved dispersion maximizes the interaction between GO and zinc ions, facilitating the formation of the metal-organic framework (MOF). In some embodiments, the first solution is sonicated for about 20 to 40 minutes, 20 to 30 minutes, 30 to 40 minutes, and 25 to 35 minutes with cycles of a 30-second pulse on followed by a 3-second pulse off. In a preferred embodiment, the GO dispersion is sonicated at 50% amplitude for 30 min (30 seconds pulse on/3 seconds off) using a probe sonicator. In some embodiments, any mixing/agitation methods known in the art may also be used.

At step 58, the method 50 includes dissolving a benzimidazole in the polar protic solvent to form a second solution. When benzimidazole is added to a polar protic solvent, such as methanol, benzimidazole interacts favorably with the solvent due to its polar nature, allowing it to dissolve effectively. At step 58, benzimidazole acts as the organic linker in synthesizing the GO@ZIF-7 nanocomposite. The nitrogen atoms in the benzimidazole ring can effectively bind to the zinc ions, facilitating the formation of a stable network that enhances the structural integrity of the composite.

In some embodiments, other imidazole-based ligands may also be used. Exemplary imidazole-based ligands that may be applicable to the current disclosure include, but are not limited to, imidazole, 2-methylimidazole, 4-methylimidazole, 2-ethylimidazole, 2-isopropylimidazole, 4-tert-butyl-1H-imidazole, 2-ethyl-4-methylimidazole, 2-bromo-1H-imidazole, 4-bromo-1H-imidazole, 2-chloro-1H-imidazole, 2-iodoimidazole, 2-nitroimidazole, 4-nitroimidazole, (1H-imidazol-2-yl) methanol, 4-(hydroxymethyl) imidazole, 2-aminoimidazole, 4-(trifluoromethyl)-1H-imidazole, 4-cyanoimidazole, 3H-imidazole carboxylic acid, 4-imidazolecarboxylic acid, imidazole-2-carboxylic acid, 2-hydroxy-1H-imidazole-4-carboxylic acid, 4,5-imidazoledicarboxylic acid, 5-iodo-2-methyl-1H-imidazole, 2-methyl-4-nitroimidazole, 2-(aminomethyl) imidazole, 4,5-dicyanoimidazole, 4-imidazoleacetic acid, 4-methyl-5-imidazolemethanol, 1-(4-methyl-1H-imidazol-5-yl) methanamine, 4-imidazoleacrylic acid, 5-bromo-2-propyl-1H-imidazole, ethyl-(1H-imidazol-2-ylmethyl)-amine, and 2-butyl-5-hydroxymethylimidazole.

At step 60, the method 50 includes mixing the first solution containing graphene oxide (GO) and zinc ions and the second solution of dissolved benzimidazole to form a third solution. This combination facilitates a series of coordination reactions, where the nitrogen atoms in benzimidazole coordinate with the zinc ions present in the first solution. The polar protic solvent helps maintain a conducive environment for these interactions, causing both the zinc ions and the organic linker to be uniformly distributed throughout the mixture. This integration enhances the structural stability and porosity of the final composite, influencing its adsorption properties. The mixing process must be done gently yet thoroughly to result in homogeneity, as inconsistencies could lead to uneven distribution of the components, affecting the performance of the nanocomposite.

In some embodiments, the concentration of Zn(NO₃)₂·6H₂O in the third solution may be range from 0.15 to 0.35 M, 0.15 to 0.25 M, 0.2 to 0.25 M, 0.2 to 0.3 M and 0.3 to 0.35 M. In a preferred embodiment, the concentration of Zn(NO₃)₂·6H₂O in the third solution is 0.25 M.

In some embodiments, the concentration of benzimidazole in the third solution may be range from 0.5 to 1.5 M, 0.5 to 1.0 M, 0.75 to 1.0 M, 0.75 to 1.25 M, and 0.75 to 1.5 M. In a preferred embodiment, the concentration of benzimidazole in the third solution is 1.0 M.

At step 62, the method 50 includes autoclaving the third solution for 20 to 30 hours at a temperature of 120 to 140° C. to form a product. Autoclaving creates a high-pressure environment that enhances the solubility and reactivity of the components within the solution. In some embodiments, the third solution may be autoclaved at a temperature of 60° C., 80° C., 90° C., 100° C., 120° C., 140° C. and 150° C. In a preferred embodiment, autoclaving the third solution may be at 130° C. The elevated temperature accelerates the coordination reactions between the zinc ions and the benzimidazole linkers, promoting the formation of the nanocomposite. In some embodiments, the third solution may be autoclaved for 10 hours, 12 hours, 15 hours, 18 hours, and 25 hours. In a preferred embodiment, the third solution is autoclaved for 24 hours. This extended duration of heating allows the reaction to reach completion, and allows for the thorough crystallization of the MOF and its integration with the graphene oxide. The presence of water vapor in the autoclave also helps maintain the required conditions for the growth of the crystalline structure, preventing the formation of undesired byproducts.

At step 64, the method 50 includes washing the product in the polar protic solvent. This washing step removes any unreacted starting materials, byproducts, or impurities that may have formed during the synthesis process, particularly those that could interfere with the composite's performance in later applications. In a preferred embodiment, the product is washed with a polar protic solvent, such as methanol, one or many times till a pure product is obtained. Optionally, other polar protic solvents may also be used.

At step 66, the method 50 includes drying the product to form the nanocomposite material. This drying process removes any residual moisture or solvents that may be present following the washing step, which stabilizes the structure of the nanocomposite. In some embodiments, drying the product may be carried out at 40 to 60° C., 45° C., 48° C., 55° C., and 60° C. to form the nanocomposite material. In a preferred embodiment, drying the product is carried out at 50° C. to form the nanocomposite material. Gentle heating promotes the evaporation of the polar protic solvent while preserving the integrity of the functional groups of graphene oxide and the structural framework of the metal-organic composite. This step also aids in achieving the desired level of porosity, which enhances the adsorption capabilities of the material. Furthermore, proper drying enhances the mechanical stability and shelf-life of the GO@ZIF-7 nanocomposite, allowing it to retain its effectiveness for applications such as environmental remediation and pollutant removal. The nanocomposite may be dried using an oven or any other heating devices/methods known in the art.

The nanocomposite material includes graphene oxide, and a zeolitic imidazolate framework-7 (ZIF-7). The nanocomposite material combines the advantages of graphene oxide and zeolitic imidazolate framework-7 (ZIF-7). Graphene oxide is valued for its mechanical strength, electrical conductivity, and large surface area, making it ideal for reinforcing composites. Its functional groups facilitate effective bonding and uniform dispersion of ZIF-7. Conversely, ZIF-7 contributes exceptional porosity, high surface area, and tunable pore sizes, improving adsorption and catalysis. This synergistic combination enhances mechanical properties, thermal stability, and functionality.

In some embodiments, the graphene oxide may be present in an amount of 25 to 40 percent by weight (wt. %) based on a total weight of the nanocomposite material, 30 to 35 percent by weight (wt. %) based on the total weight of the nanocomposite material. In a preferred embodiment, the graphene oxide is present in an amount of 33 percent by weight (wt. %) based on the total weight of the nanocomposite material.

In some embodiments, the morphology of graphene oxide may be nanosheets, nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, etc., and mixtures thereof. In a preferred embodiment, graphene oxide is of a roughly spherical morphology characterized by a uniform average size distribution within the range of 500 nm to 1 μm. This uniformity in size suggests that the synthesis process of GO was well-controlled, likely resulting in consistent particle formation that can enhance its performance in various applications, such as composites and catalysis. The spherical particles facilitate better dispersion in matrices, improving interactions with other materials.

In some embodiments, the morphology of nanocomposite GO@ZIF-7 may be nanosheets, nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, etc., and mixtures thereof.

In some embodiments, nanocomposite GO@ZIF-7 may have particles with dimensions from 0.5 to 5 μm, 0.5 to 1 μm, 0.5 to 2 μm, 0.5 to 3 μm, 0.5 to 4 μm and 1 to 5 μm. In a preferred embodiment, the nanocomposite GO@ZIF-7 particles have a size ranging from 100 nm to 5 μm. Smaller size particles facilitate enhanced dispersion within solution, which maximizes the contact area with contaminants—and hence leads to improved efficacy in pollutant removal.

In one or more embodiments, GO@ZIF-7 particles have a diverse morphology from spherical to irregular shapes. This variation in morphology indicates a more complex formation process for ZIF-7 and its composite with GO, reflecting the influence of the interaction between the two components during formation. In one or more embodiments, the irregular shapes enhance the surface area and porosity of the ZIF-7 framework.

The ratio of relative atomic concentration of nitrogen to zinc in the nanocomposite material affects the adsorption properties, particularly for pollutant removal applications. A balanced nitrogen-to-zinc ratio enhances the nanocomposite's surface chemistry, creating more active sites that facilitate the adsorption of organic pollutants. Nitrogen atoms can introduce functional groups that improve binding interactions, thereby increasing the nanocomposite's affinity for target molecules. This enhancement can lead to higher adsorption capacities and more efficient capture of contaminants from water, making the nanocomposite highly effective for environmental remediation applications. In some embodiments, the ratio of relative atomic concentration of nitrogen to zinc may range from 2.5 to 5, 2.5 to 3.0, 2.5 to 4, 3.0 to 4.0, 4.0 to 5.0, and 3.0 to 4.5.

In one or more embodiments, as according to elemental mapping and energy dispersive X-ray spectroscopy (EDS) analysis of the GO@ZIF-7 particles, GO@ZIF-7 nanocomposite particles have carbon as the predominant element along with other elements including zinc, nitrogen, and oxygen. In a preferred embodiment, the respective atomic ratio of N to Zn is about 3.6, which is close to the anticipated atomic ratio of about 4 in the nanocomposite. In a preferred embodiment, the GO content in the nanocomposite predicted from the EDS analysis results is about 33 wt. %.

FIG. 1B illustrates a schematic flow chart of method 70 of the method of water decontamination. The order in which the method 70 is described is not intended to be construed as a limitation, and any number of the described method steps can be combined to implement the method 70. Additionally, individual steps may be removed or skipped from the method 70 without departing from the spirit and scope of the present disclosure.

At step 72, the method 70 includes contacting the nanocomposite material (GO@ZIF-7) with an aqueous solution to form a reaction mixture. The aqueous solution comprises one or more pollutants. This step initiates the interaction between the nanocomposite and the pollutants in the aqueous solution. The aqueous solution serves as a medium through which the pollutants, such as organic dyes or other hazardous substances, can be effectively delivered to the surface of the GO@ZIF-7 nanocomposite. In some embodiments, contacting the nanocomposite material with an aqueous solution may performed for 20 hours, 21 hours, 22 hours, 23 hours, 25 hours, 26 hours, 27 hours, and 28 hours. In a preferred embodiment, contacting the nanocomposite material with an aqueous solution is performed for 24 hours.

The unique structural properties of GO@ZIF-7, characterized by its high surface area and porous framework, facilitate the adsorption of these pollutants, allowing for an increase in contact between the adsorbent and the contaminants. In some embodiments, the nature of the interaction between the nanocomposite and the pollutants in the aqueous solution through van der Waals forces, hydrogen bonding, and/or electrostatic interactions.

In some embodiments, the concentration of nanocomposite material in the reaction mixture may be range from 50 to 150 mg/L, 50 to 90 mg/L, 50 to 110 mg/L, 50 to 120 mg/L, 50 to 140 mg/L, 70 to 150 mg/L and 90 to 150 mg/L. In a preferred embodiment, the concentration of nanocomposite material in the reaction mixture is about 100 mg/L.

At step 74, the method 70 includes mixing the reaction mixture. This step enables optimal interaction between the nanocomposite material (GO@ZIF-7) and the pollutants present in the aqueous solution. This mixing process facilitates uniform dispersion of the GO@ZIF-7 particles throughout the solution, promoting increased contact between the adsorbent and the target pollutants. Mixing may be performed using mechanical stirring or magnetic agitation techniques. Also, mixing may help to break down any potential agglomerates of the nanocomposite, allowing individual particles to be available for adsorption. Furthermore, maintaining a consistent mixing speed and duration aids in achieving reproducible results, as it influences the mass transfer rates and, consequently, pollutant removal efficiency. In some embodiments, the reaction mixture may mixed by shaking the reaction mixture at 200 rpm, 220 rpm, 240 rpm, 260 rpm, 280 rpm, and 300 rpm. In a preferred embodiment, the reaction mixture is mixed by shaking at 250 rpm.

At step 76, the method 70 includes collecting a filtrate. After the mixing step, where the GO@ZIF-7 nanocomposite effectively interacts with the pollutants in the aqueous solution, a subsequent filtration process is employed to separate the solid adsorbent material from the liquid phase. In some embodiments, the filtration can be conducted using various techniques, such as gravity filtration, membrane filtration, pressure filtration, suction filtration, and vacuum filtration, depending on the particle size of the nanocomposite. In a preferred embodiment, the filtration is conducted by centrifugation to obtain the filtrate. The filtrate has fewer of the one or more pollutants than the aqueous solution, which have been absorbed by the adsorbent.

In some embodiments, initial concentration of pollutants may be in the range of 50-500 mg/L, preferably including 50 mg/L, 100 mg/L, 150 mg/L, 200 mg/L, 250 mg/L, 300 mg/L, 350 mg/L, 400 mg/L, 450 mg/L and 500 mg/L. In a preferred embodiment, the initial concentration of pollutants (methyl orange and o-cresol) is 100 mg/L or 500 mg/L.

In some embodiments, the nanomaterial (GO@ZIF-7) may have an uptake capacity for methyl orange of 3800, 3850, 3900, 3950 and 4000 mg/g at an initial concentration of 500 mg/L of the methyl orange. In a preferred embodiment, the nanomaterial (GO@ZIF-7) has an uptake capacity for methyl orange of 3887 mg/g at an initial concentration of 500 mg/L of the methyl orange.

In some embodiments, the nanomaterial (GO@ZIF-7) may have an uptake capacity for methyl orange of 700, 750, 800, 850 and 900 mg/g at an initial concentration of 100 mg/L of the methyl orange. In a preferred embodiment, the nanomaterial (GO@ZIF-7) has an uptake capacity for methyl orange of 777 mg/g at an initial concentration of 500 mg/L of the methyl orange.

In some embodiments, the nanomaterial (GO@ZIF-7) may have an uptake capacity for o-cresol of 1300, 1350, 1400, 1450 and 1500 mg/g at an initial concentration of 500 mg/L of the o-cresol. In a preferred embodiment, the nanomaterial (GO@ZIF-7) has an uptake capacity for o-cresol of 1439 mg/g at an initial concentration of 500 mg/L of the o-cresol.

In some embodiments, the nanomaterial (GO@ZIF-7) may have an uptake capacity for o-cresol of 350, 400, 450, 500 and 550 mg/g at an initial concentration of 100 mg/L of the o-cresol. In a preferred embodiment, the nanomaterial (GO@ZIF-7) has an uptake capacity for o-cresol of 421 mg/g at an initial concentration of 500 mg/L of the o-cresol.

These results highlight the versatility of GO@ZIF-7 in efficiently removing pollutants across varying concentrations, which is useful for practical applications in wastewater treatment. The ability to retain high adsorption capacities at high and low pollutant concentrations demonstrates the nanocomposite's potential for addressing environmental challenges posed by dye pollutants, improving water quality and reducing ecological impact.

### EXAMPLES

The following examples provide a nanocomposite including a graphene oxide (GO) and a zeolitic imidazolate framework-7 (ZIF-7). The examples are provided solely for illustration and are not to be construed as limitations of the present disclosure, as many variations thereof are possible without departing from the spirit and scope of the present disclosure.

### Example 1: Synthesis of GO

GO was prepared by mixing 360 milliliters (mL) of sulfuric acid (H₂SO₄) and 40 mL of phosphoric acid (H₃PO₄) in a H₂SO₄:H₃PO₄ volumetric ratio of 9:1 in a flask. In order to regulate the temperature, the flask was placed in an ice bath. Further, 3 grams (g) of graphite powder was added to the above mixture, followed by an addition of 18 g of KMnO₄ while continuously stirring the solution in the flask. The reaction mixture was then transferred to a warm water bath and stirred for 12 h at 50° C. Further, the reaction mixture was poured into about 400 g of crushed ice, followed by the slow addition of about 5 mL of H₂O₂ until the mixture color turned a dark yellow. Furthermore, the mixture was stirred continuously for 12 h at room temperature. The mixture was washed consecutively, three times, with distilled water and 10 percent by volume (vol. %) HCl solution. The solid was recovered after each wash cycle by centrifugation at 8000 rpm. In addition, GO was further rinsed several times with distilled water to remove the acid. Finally, the obtained GO was dried at 50° C., and ground to produce fine powder.

### Example 2: Synthesis of ZIF-7

In the synthesis of ZIF-7, 5.94 g Zn(NO₃)₂·6H₂O was added to 40 mL HPLC grade methanol. In a separate beaker, 9.44 g benzimidazole was added to 40 mL HPLC grade methanol. The two solutions were then stirred at room temperature until the solid materials were completely dissolved. Further, the zinc solution was poured quickly into the benzimidazole solution while stirring for 1 h at room temperature. The mixture was then transferred into a Teflon-lined autoclave reactor and kept in an oven at 130° C. for 24 h. Further, the autoclave reactor was removed from the oven and left to cool down naturally. Furthermore, the formed ZIF-7 powder was purified via several washes with HPLC grade methanol. The solid ZIF-7 material was recovered after each wash using centrifugation at 6000 revolutions per minute (rpm). The purified ZIF-7 was dried at 50° C. The dried ZIF-7 powder was ground to obtain a fine powder. The ZIF-7 powder was stored in an air-tight container.

### Example 3: Synthesis of GO@ZIF-7 nanocomposite

To prepare GO@ZIF-7 nanocomposite, 5.94 g Zn(NO₃)₂·6H₂O was added to 40 mL HPLC grade methanol, followed by stirring until the zinc salt was completely dissolved. Further, 0.25 g GO was added to the above solution and stirred at room temperature for 5 min to disperse GO. Furthermore, the GO dispersion was sonicated at 50% amplitude for 30 min (30 seconds pulse on with 3 seconds pulse off) using a probe sonicator. The remaining preparation steps are similar to those used to prepare ZIF-7, as described above.

### Example 4: Characterizations

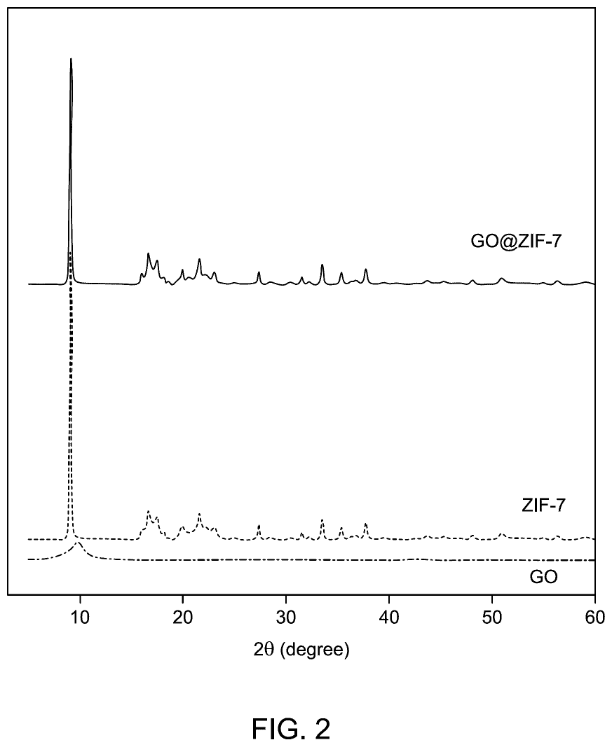

The X-ray diffraction (XRD) patterns of GO, ZIF-7, and the GO@ZIF-7 nanocomposite are depicted in FIG. 2. The diffraction peaks of ZIF-7 observed at 2θ values of 9.12°, 16.0°, 16.68°, 17.52°, 19.98°, 21.6°, 23.1°, 27.39°, 31.59°, 33.54°, 35.43°, and 37.8° are consistent with those reported for ZIF-7 synthesized using diethyl formamide, ammonia atmosphere, water/ethanol mixture, and N,N-dimethylformamide as the synthesis medium. The presence of a distinct diffraction peak at an angle of 9.12° suggests a microporous ZIF-7 structure. ZIF-7 may exist in phases I, II, or III depending on the synthesis conditions and media, and the diffraction peaks shown in FIG. 2 suggest the phase III crystalline form for the synthesized ZIF-7. The ZIF-7 phase exhibits a square planar structure with a (4,4) configuration. In general, such a structure is generated by the coordination of benzimidazolate tetrahedra with quadruply connected corner-shared networks of Zn(II). The ZIF-7 III phase is the densest among all other phases of ZIF-7 and many other ZIFs. Additionally, it is the most stable phase of ZIF-7. FIG. 2 further displays the XRD diffraction pattern of GO, indicating a solitary weak diffraction peak at 9.8°. Furthermore, FIG. 2 illustrates the XRD pattern of the GO@ZIF-7 nanocomposite. As can be seen from FIG. 2, the XRD patterns of both ZIF-7 and GO@ZIF-7 nanocomposite exhibit similarities. The similarity is supported by the weak intensity of the GO diffraction peak at 9.8°, which is approximately 5% of the intensity of the ZIF-7 peak observed at a nearby angle of 9.12°. The proximity of the small GO and the intense ZIF-7 diffraction peaks may lead to the obscuration of the GO diffraction peak by that of ZIF-7. Furthermore, relatively small amount of GO present in the GO@ZIF-7 nanocomposite (about 1.63% of the total mass of the ZIF-7 precursors in the synthesis solution) is another reason for the similarities observed in the XRD patterns of ZIF-7 and GO@ZIF-7 nanocomposite.

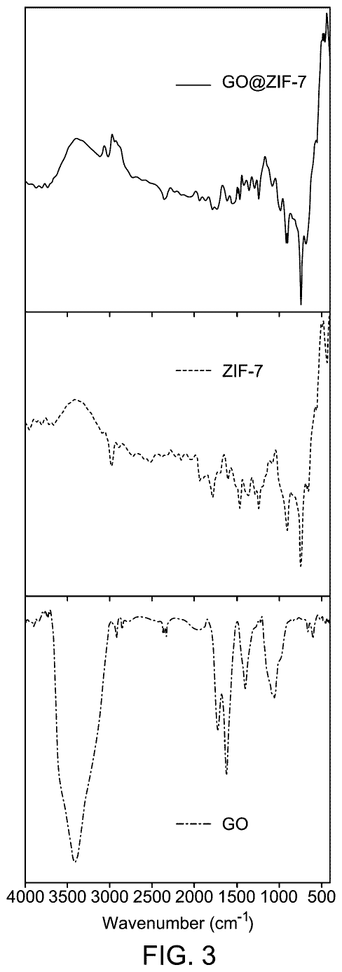

FIG. 3 displays the Fourier transform infrared (FTIR) spectra of GO, ZIF-7, and the GO@ZIF-7 nanocomposite. The respective GO spectra exhibit a broad and strong absorption peak at around 3417 cm⁻¹. This peak originates from the stretching vibration of O—H bonds, which is a result of the presence of water moisture and/or the deliquescence of KBr. The peaks located at 2936 cm⁻¹ and 2855 cm⁻¹ are ascribed to the bending vibration of the C—H bond within the GO framework. The peak at 1730 cm⁻¹ corresponds to the stretching vibration of the C═O bond, whereas the rather high peak at 1636 cm⁻¹ is associated with the vibration of the sp² hybridized carbons in the graphitic structure. Additionally, the absorption peaks at 1385 cm⁻¹ and 10⁶⁰ cm⁻¹ correspond to the bending of the alcohol bond (O—H) and the stretching vibrations of the C—H bond, respectively.

Additionally, FIG. 3 also showcases the FTIR spectra of both ZIF-7 and the GO@ZIF-7 nanocomposite. The FTIR spectra of ZIF-7 and GO@ZIF-7 nanocomposite exhibit similarities, possibly attributed to the low concentration of GO present in the nanocomposite, as previously mentioned. However, despite the low GO level in the nanocomposite, the incorporation of GO into the ZIF-7 framework led to a substantial enhancement in Pb(II) adsorption. FIG. 3 further depicts a plurality of other peaks for ZIF-7 and GO@ZIF-7 within the range of 2700 cm⁻¹ to 3100 cm⁻¹ that are likely caused by the stretching vibration of the O—H bonds in the remaining alcohol present after the synthesis and purification processes. Furthermore, the peaks observed within 1700 cm⁻¹ to 2000 cm⁻¹ may be attributed to the bending vibration of the C—H bond in the benzyl ring of the organic linker, specifically benzimidazole. On the other hand, the absorption peaks detected within 1500 cm⁻¹ to 1700 cm⁻¹ may be attributed to C═C bond stretching in the benzimidazole aromatic ring. The peaks observed within 1300 cm⁻¹ to 1365 cm⁻¹ are likely caused by the stretching of the C—N bonds. Similarly, the peak seen at 750 cm⁻¹ is linked to the out-of-plane bending stretching of the aromatic ring, while the peak observed at 900 cm⁻¹ is linked to the in-plane bending stretching of the aromatic ring. In addition, the peak observed at 430 cm⁻¹ suggests the stretching vibration of the Zn—N bond formed between the organic linker and the Zn atom.

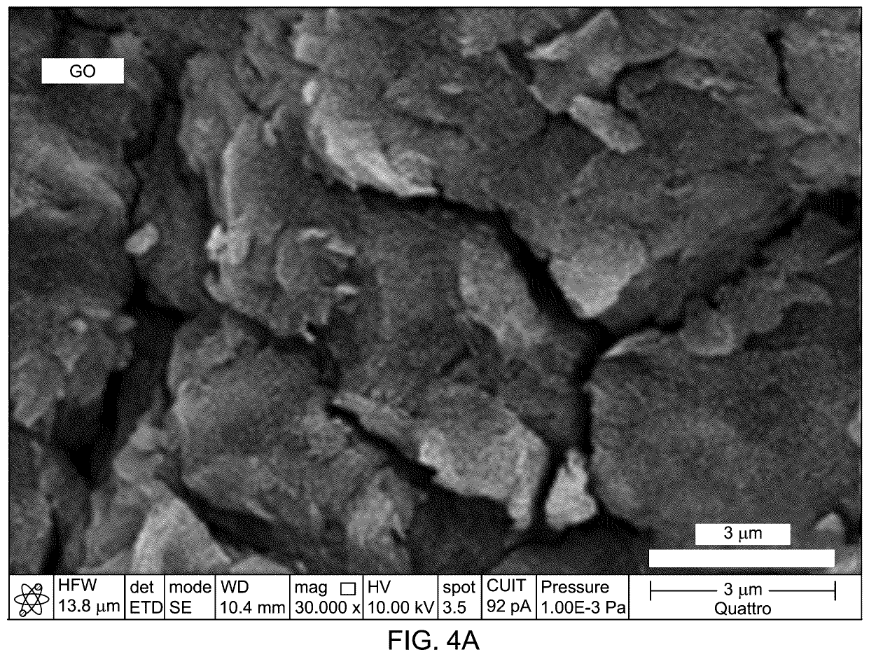

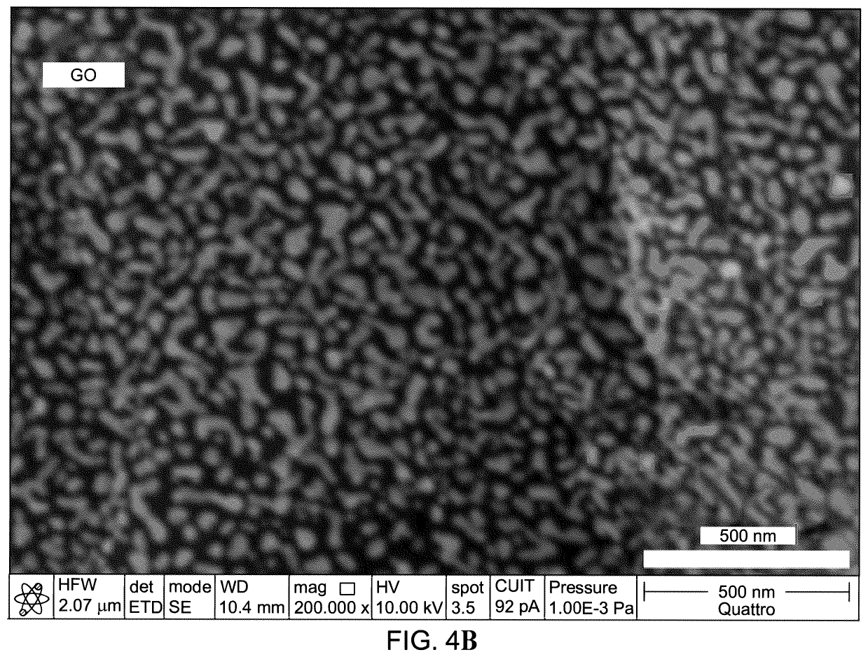

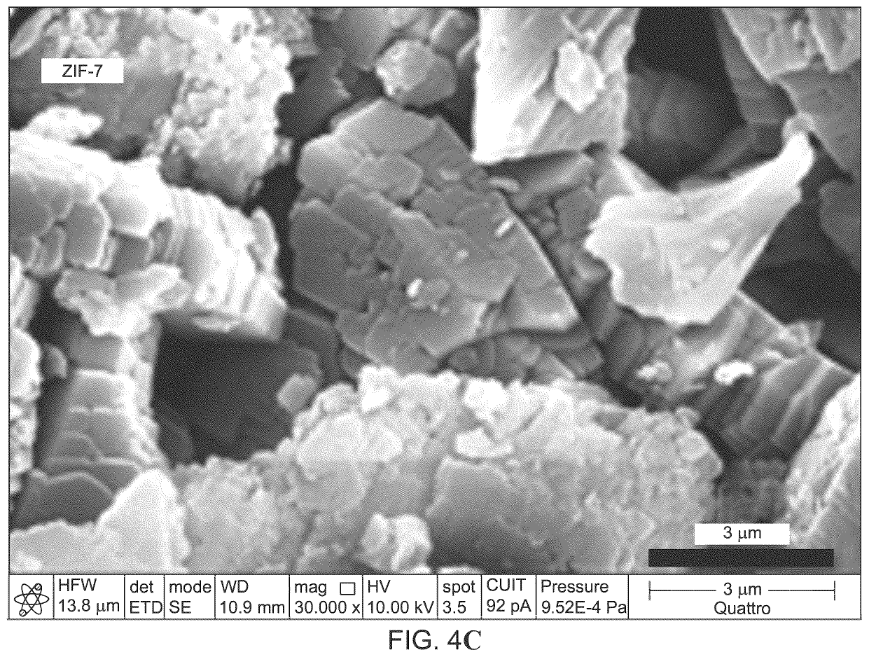

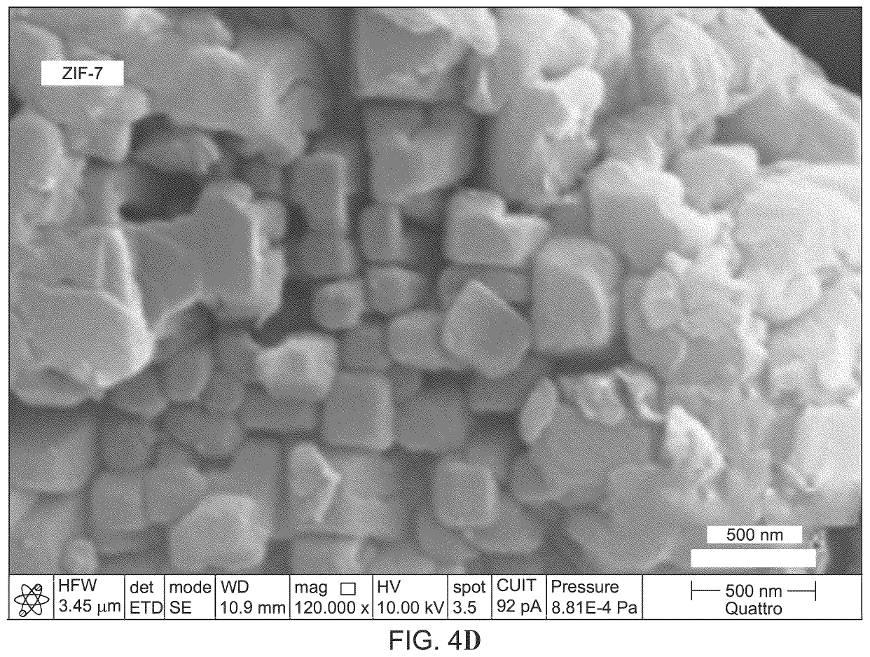

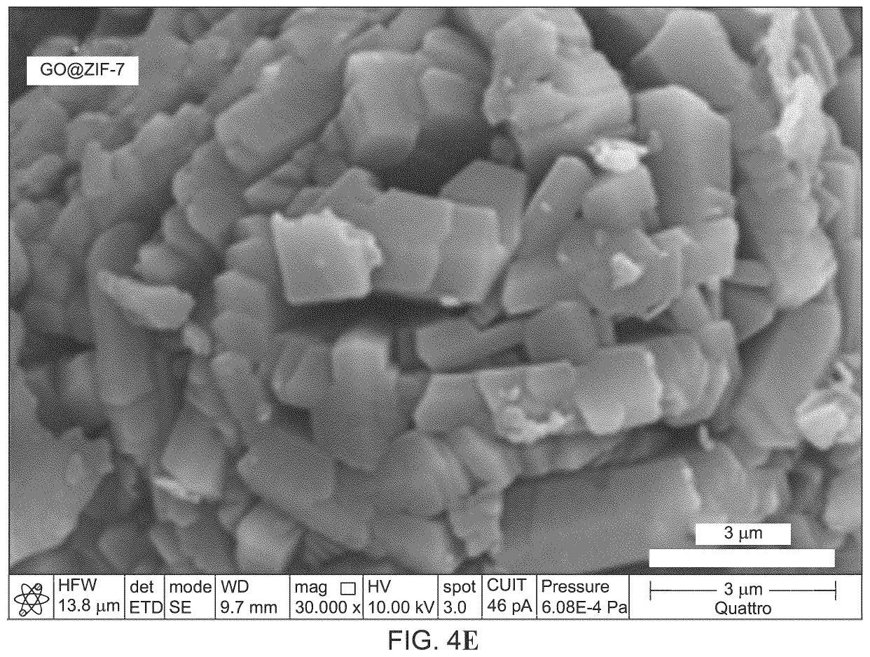

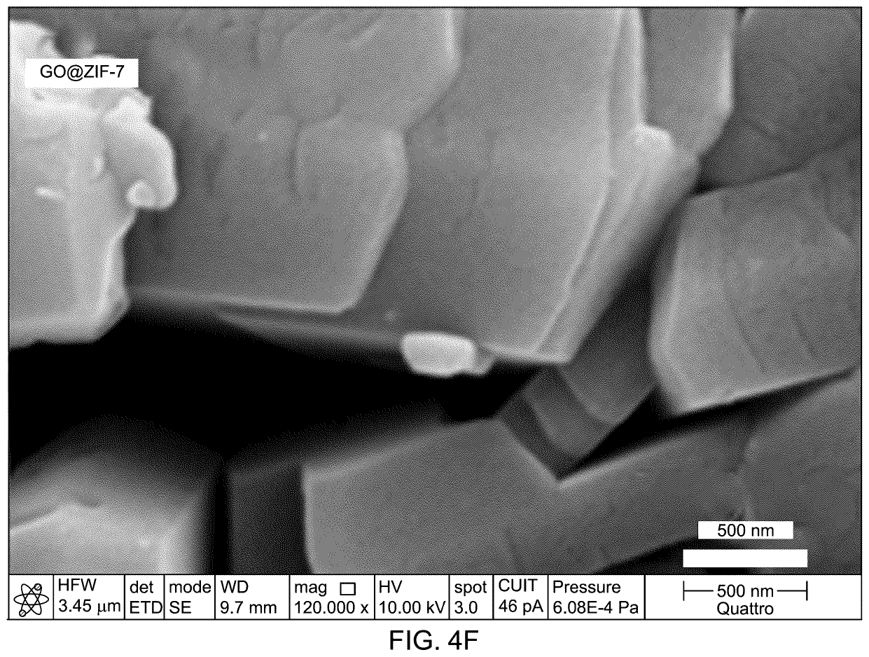

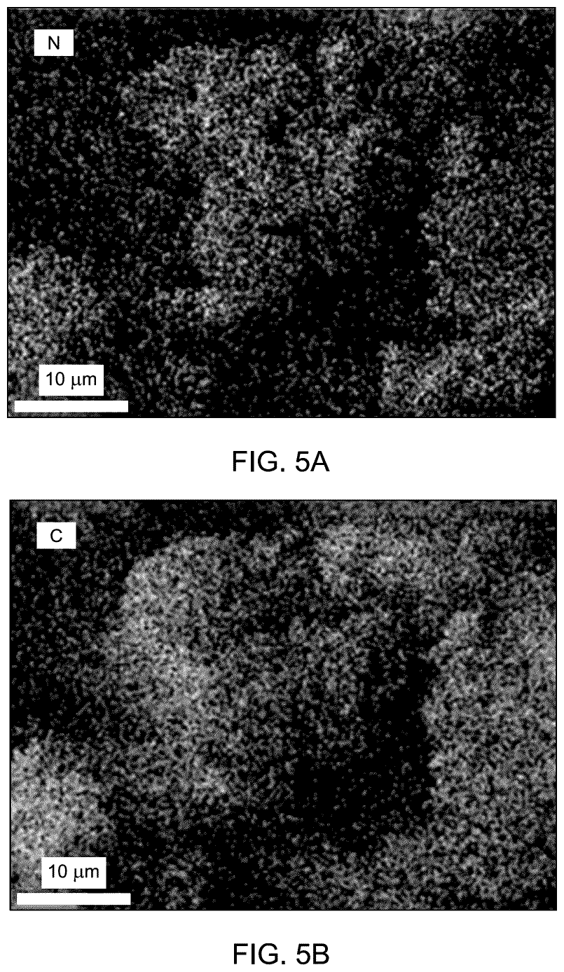

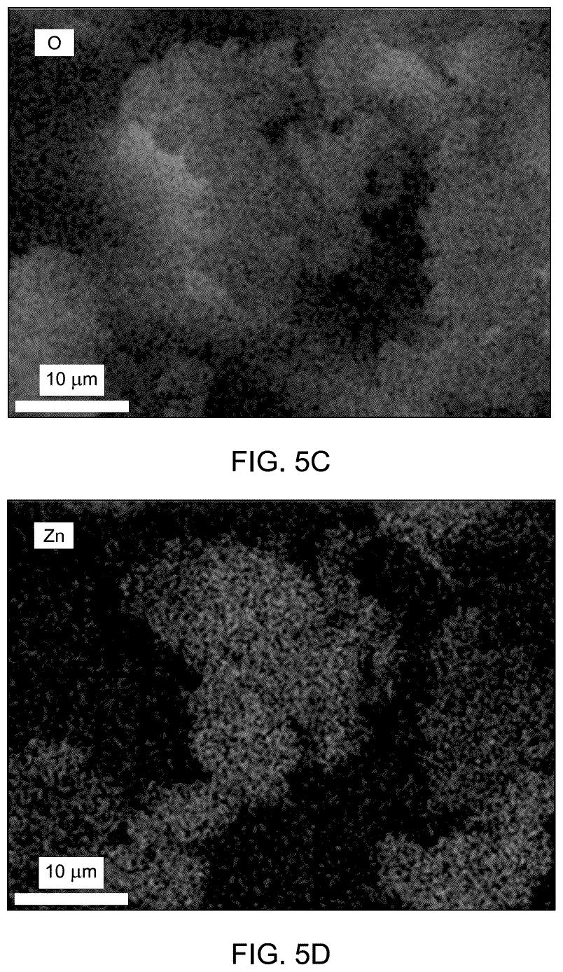

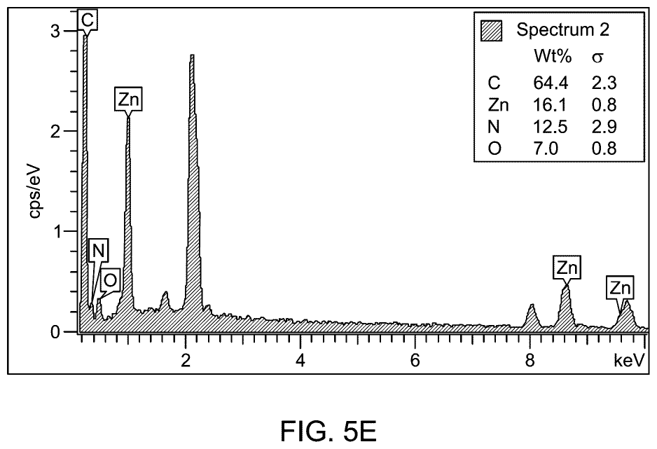

Referring to FIGS. 4A-4F, optical images depicting scanning electron microscope (SEM) analysis of GO, ZIF-7, and GO@ZIF-7 are illustrated. FIG. 4A and FIG. 4B reveals predominantly spherical particles, characterized by their uniform size distribution within the 500 nm to 1 μm range, suggesting a controlled synthesis process. In contrast, SEM analyses of ZIF-7, and GO@ZIF-7 as presented in FIG. 4C, FIG. 4D, FIG. 4E, and FIG. 4F show a diverse morphology from spherical to irregular and sizes approximately ranging from 100 nm to 5 μm. The elemental mapping and energy dispersive X-ray spectroscopy (EDS) analysis of the GO@ZIF-7, as depicted in FIGS. 5A-5E, shows carbon as the predominant element along with other elements including zinc, nitrogen, and oxygen. The respective atomic ratio of N to Zn was calculated to be about 3.6, which is close to the anticipated atomic ratio of about 4 in the nanocomposite. The GO content in the nanocomposite predicted from the EDS analysis results is about 33 wt. %. The SEM analysis, in conjunction with the EDS analysis, provide an overview of the morphology and composition of the GO@ZIF-7 nanocomposite.

### Example 5: Water Decontamination Tests

The adsorption performance of GO@ZIF-7 was compared to those of GO and ZIF-7. In these experiments, the adsorbent dosage, sample volume, adsorption time, and shaking speed were fixed at 100 mg/L, 100 mL, 24 h, and 250 rpm, respectively. Two MO and OC concentrations (100 mg/L and 500 mg/L) were prepared using distilled water and utilized in these experiments to measure the uptake capacity by the above 3 adsorbents. The uptake capacity (qₑ) was calculated using the following equation:

$${q}_{e} = \frac{( {C}_{i} - {C}_{f} ) \cdot V}{m}$$

Where, Cᵢ is the initial MO and OC concentrations and Cf is the final MO and OC concentrations, V is the sample volume, and m is the adsorbent mass.

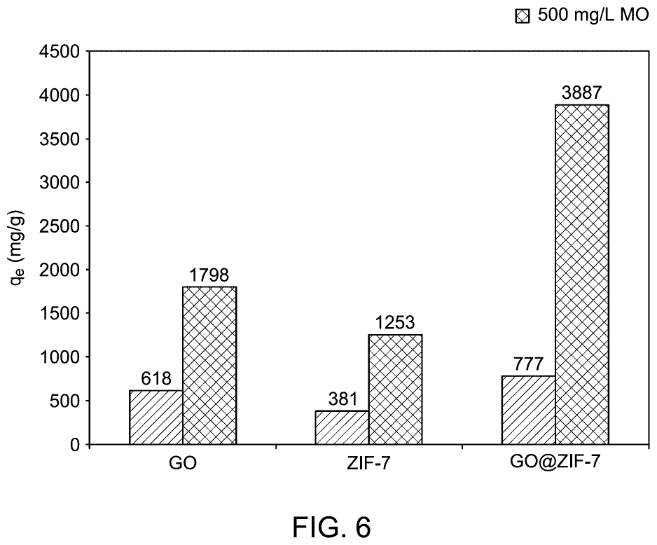

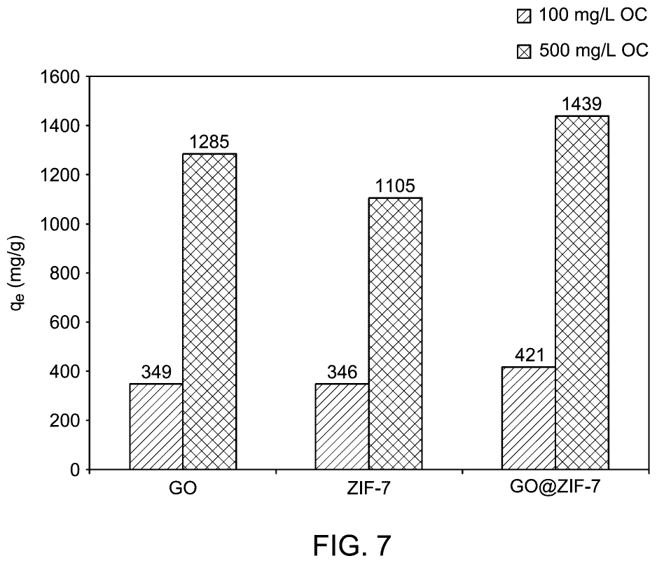

The adsorption of MO and OC on GO, ZIF-7, and GO@ZIF-7 nanocomposite is shown in FIG. 6 and FIG. 7. As depicted in FIG. 6 and FIG. 7, the adsorption capacity of MO and OC on GO@ZIF-7 nanocomposite is 777 mg/g and 421 mg/g respectively, when the adsorption took place from 100 mg/L solution. This uptake capacity by the GO@ZIF-7 nanocomposite is higher than its adsorption on the parental materials of GO and ZIF-7. Increasing the initial concentration to 500 mg/L resulted in a huge boost in the adsorption capacity of the GO@ZIF-7 nanocomposite, reaching 3887 mg/g and 1439 mg/g respectively, which is higher than the adsorption capacity of GO and ZIF-7. These results demonstrate the improved performance of the GO@ZIF-7 nanocomposite relative to GO and ZIF-7.

In addition to the high uptake capacity by the GO@ZIF-7 nanocomposite, the removal of MO and OC from wastewater samples under various conditions was investigated. High pollutant removal may be obtained at ideal process conditions. The results obtained in this invention suggest the commercial potential of GO@ZIF-7 nanocomposite for wastewater treatment as revealed by the very high MO and OC uptake capacity and the successful treatment of respective contaminated water.

### Example 6: Response Surface Methodology (RSM) Modeling for MO Removal

The initial MO concentration, adsorbent dosage, and pH of the solution were selected as the factors for the RSM modeling. Each factor unit and respective levels are shown in Table 1. The RSM design used in the present disclosure is a randomized three numeric factors face-centered response surface methodology (FC-RSM) design with three levels for each numeric factor and five center points per block, along with the MO removal efficiency (%) as the response. Table 2 shows the full FC-RSM design of the experiments.

TABLE 1
FC-RSM factors and levels

| Factors | Levels | | |
|---|---|---|---|
| A = pH | 2 | 4 | 6 |
| B = Initial MO | 50 | 100 | 150 |
| concentration (mg/L) | | | |
| C = Adsorbent dosage | 200 | 400 | 600 |
| (mg/L) | | | |

TABLE 2
Full FC-RSM design of experiments along with the obtained
MO removal parentage at each experimental condition

| Exp. No. | A | B | C | MO removal (%) |
|---|---|---|---|---|
| 1 | 4 | 100 | 200 | 65.1 |
| 2 | 2 | 150 | 200 | 49.6 |
| 3 | 2 | 150 | 600 | 60.2 |
| 4 | 6 | 150 | 600 | 88.6 |
| 5 | 4 | 100 | 400 | 74.6 |
| 6 | 4 | 150 | 400 | 80.7 |
| 7 | 6 | 50 | 200 | 73.1 |
| 8 | 2 | 50 | 600 | 68.4 |
| 9 | 6 | 100 | 400 | 83.4 |
| 10 | 4 | 50 | 400 | 72.0 |
| 11 | 2 | 100 | 400 | 47.6 |
| 12 | 2 | 50 | 200 | 51.5 |
| 13 | 6 | 50 | 600 | 89.6 |
| 14 | 6 | 150 | 200 | 73.1 |
| 15 | 4 | 100 | 600 | 88.0 |

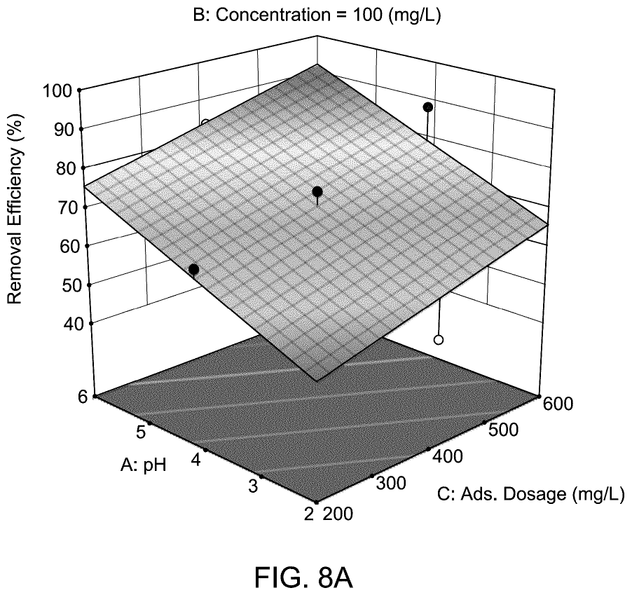

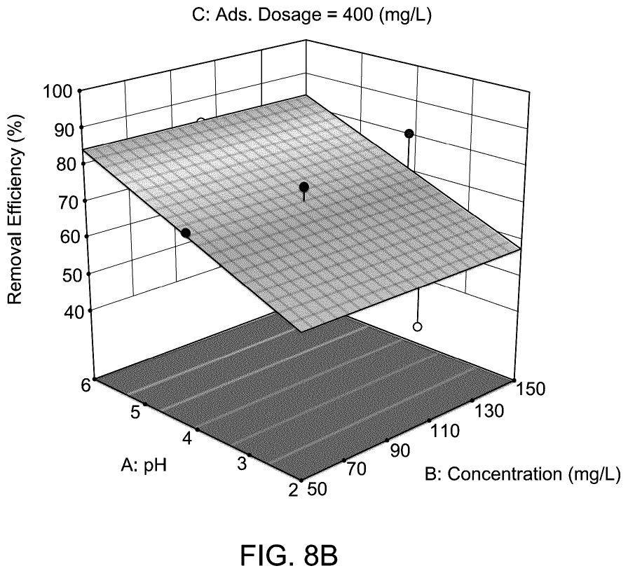

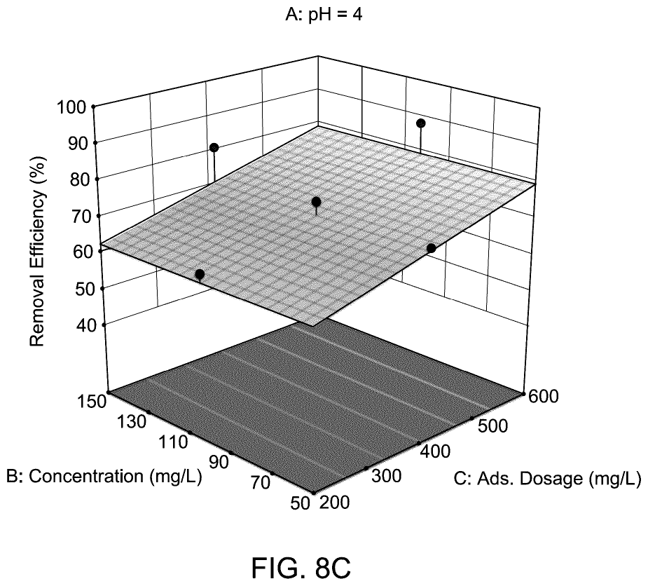

RSM results illustrated in FIGS. 8A-8C, which shows the effects of operational parameters on MO removal. FIG. 8A shows that the removal efficiency of MO, at a fixed initial MO concentration of 100 mg/L, is enhanced with an increase in pH of the aqueous solution.

### Example 6: Response Surface Methodology (RSM) Modeling for OC Removal

The initial OC concentration, adsorbent dosage, and pH of the solution were selected as the factors for the RSM modeling. Each factor unit and respective levels are shown in Table 3. The RSM design used in the present disclosure is a randomized three numeric factors face-centered (FC-RSM) design with three levels for each numeric factor and five center points per block, along 10 with the OC removal efficiency (%) as the response. Table 4 shows the full FC-RSM design of the experiments.

TABLE 3
FC-RSM factors and levels

| Factors | Levels | | |
|---|---|---|---|
| A = pH | 2 | 4 | 6 |
| B = Initial OC | 50 | 100 | 150 |
| concentration (mg/L) | | | |
| C = Adsorbent | 200 | 400 | 600 |
| dosage (mg/L) | | | |

TABLE 4
Full FC-RSM design of experiments along with the obtained
OC removal parentage at each experimental condition

| Exp. No. | A | B | C | OC removal (%) |
|---|---|---|---|---|
| 1 | 6 | 150 | 200 | 61.4 |
| 2 | 2 | 100 | 400 | 50.1 |
| 3 | 2 | 150 | 200 | 55.2 |
| 4 | 4 | 100 | 400 | 61.7 |
| 5 | 4 | 100 | 200 | 60.3 |
| 6 | 6 | 50 | 200 | 66.4 |
| 7 | 6 | 100 | 400 | 72.2 |
| 8 | 2 | 50 | 600 | 59.4 |
| 9 | 4 | 100 | 600 | 74.5 |
| 10 | 6 | 150 | 600 | 77.3 |
| 11 | 6 | 50 | 600 | 81.2 |
| 12 | 4 | 150 | 400 | 69.5 |
| 13 | 2 | 150 | 600 | 56.8 |
| 14 | 2 | 50 | 200 | 55.8 |
| 15 | 4 | 50 | 400 | 64.2 |

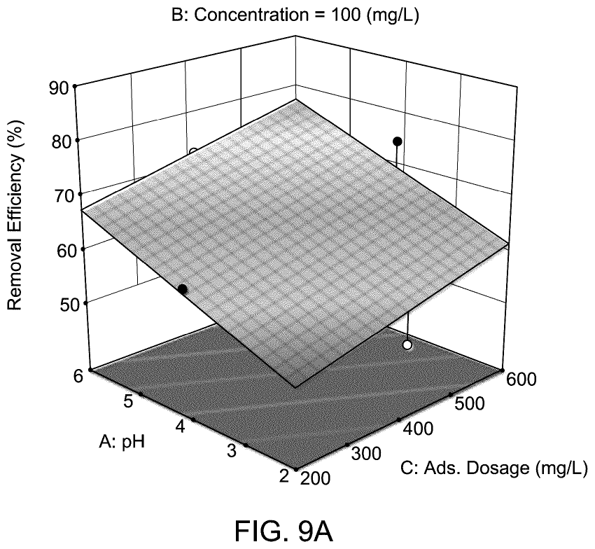

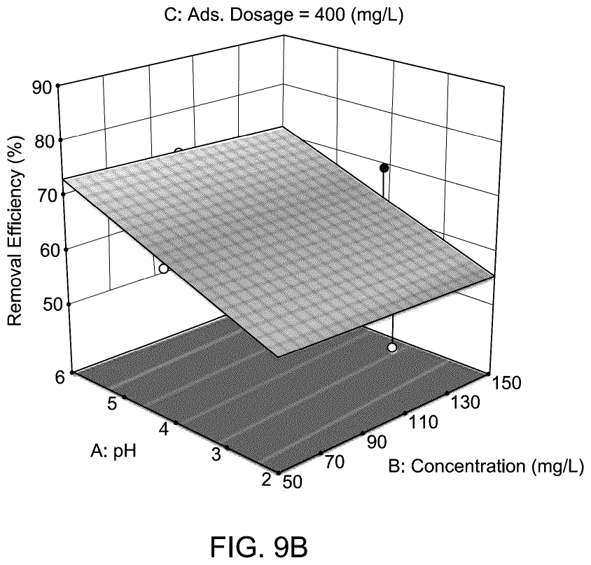

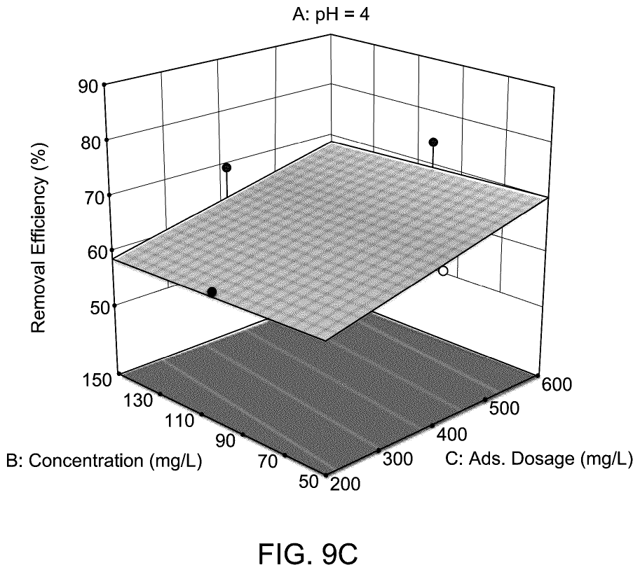

The results from the RSM, as shown in FIGS. 9A-9C, illustrate the impact of operational parameters on OC removal. FIG. 9C depicts that increasing the adsorbent dosage enhances the removal efficiency of OC, with the pH value fixed at 4.

The present disclosure provides the nanocomposite for adsorptive removal of organic pollutants from contaminated waters. As such, the present disclosure describes the development of the GO@ZIF-7 nanocomposite and its application in the decontamination of polluted water bodies, contaminated with dyes including, but not limited to, methyl orange (MO) and o-cresol (OC). The GO@ZIF-7 nanocomposite was formulated from graphene oxide (GO) and zeolitic imidazolate framework-7 (ZIF-7). Incubating the GO@ZIF-7 nanocomposite in the polluted water samples provided removal of pollutants at relatively low dosages of the GO@ZIF-7 nanocomposite. The developed material and the process used herein are effective at ambient conditions with minimal energy input and with no additional material inputs.

Numerous modifications and variations of the present disclosure are possible in light of the above teachings. It is therefore to be understood that within the scope of the appended claims, the invention may be practiced otherwise than as specifically described herein.

1. A nanocomposite material, comprising:
graphene oxide (GO); and
a zeolitic imidazolate framework-7 (ZIF-7),
wherein the graphene oxide is present in an amount of 25 to 40 percent by weight (wt. %) based on a total weight of the nanocomposite material,
wherein the nanocomposite is in the shape of particles with a longest dimension of 0.5 to 5 μm.

2. The nanocomposite material of claim 1, wherein the graphene oxide is present in the nanocomposite material in an amount of 30 wt. % to 35 wt. % based on the total weight of the nanocomposite material.

3. The nanocomposite material of claim 1, wherein the ratio of relative atomic concentrations of nitrogen to zinc is in a range from 2.5 to 5.

4. The nanocomposite material of claim 3, wherein the ratio of relative atomic concentrations of nitrogen to zinc is in a range from 3.0 to 4.5.

5. The nanocomposite material of claim 1, wherein the material has an uptake capacity for methyl orange of 3800 to 4000 mg/g when contacted with an adsorbate solution having an initial concentration of 500 mg/L of the methyl orange.

6. The nanocomposite material of claim 1, wherein the material has an uptake capacity for methyl orange of 700 to 900 mg/g when contacted with an adsorbate solution having an initial concentration of 100 mg/L of the methyl orange.

7. The nanocomposite material of claim 1, wherein the material has an uptake capacity for o-cresol of 1300 to 1500 mg/g when contacted with an adsorbate solution having an initial concentration of 500 mg/L of the o-cresol.

8. The nanocomposite material of claim 1, wherein the material has an uptake capacity for o-cresol of 350 to 550 mg/g when contacted with an adsorbate solution having an initial concentration of 100 mg/L of the o-cresol.

9. The nanocomposite material of claim 1, wherein the nanocomposite material is made by a process comprising:
dissolving a zinc salt in a polar protic solvent to form a zinc solution;
adding graphene oxide to the zinc solution to form a first solution;
sonicating the first solution;
dissolving a benzimidazole in the polar protic solvent to form a second solution;
mixing the first solution and the second solution to form a third solution;
autoclaving the third solution for 20 to 30 hours at a temperature of 120 to 140° C. to form a product;
washing the product in the polar protic solvent; and
drying the product at 40 to 60° C. to form the nanocomposite material.

10. The nanocomposite material of claim 9, wherein in the process of the making the nanocomposite material the zinc salt is Zn(NO₃)₂·6H₂O.

11. The nanocomposite material of claim 10, wherein in the process of the making the nanocomposite material the concentration of Zn(NO₃)₂·6H₂O in the third solution is in a range from 0.15 to 0.35 M.

12. The nanocomposite material of claim 9, wherein in the process of the making the nanocomposite material the polar protic solvent is methanol.

13. The nanocomposite material of claim 9, wherein in the process of the making the nanocomposite material the amount of GO present in the first solution is in a range from 10 to 30% of the weight of zinc present in the first solution.

14. The nanocomposite material of claim 9, wherein in the process of the making the nanocomposite material the concentration of benzimidazole in the third solution is in a range from 0.5 to 1.5 M.

15. The nanocomposite material of claim 9, wherein in the process of the making the nanocomposite material the sonicating the first solution is performed for 20 to 40 minutes with cycles of a 30 second pulse on followed by a 3 second pulse off.

16. The nanocomposite material of claim 9, wherein in the process of the making the nanocomposite material the autoclaving the third solution is for 24 hours at a temperature of 130° C.

17. A method of water decontamination, comprising:
contacting the nanocomposite material of claim 1 with an aqueous solution to form a reaction mixture,
wherein the aqueous solution comprises one or more pollutants,
mixing the reaction mixture; and
collecting a filtrate,
wherein the filtrate has fewer of the one or more pollutants than the aqueous solution.

18. The method of claim 17, wherein the concentration of nanocomposite material in the reaction mixture is in a range from 50 to 150 mg/L.

19. The method of claim 17, wherein the contacting the nanocomposite material of claim 1 with an aqueous solution is performed for 20 to 28 hours.

20. The method of claim 17, wherein the mixing the reaction mixture is performed by shaking the reaction mixture between 200 and 300 rpm.
